(19) United States
(12) Patent Application Publication
(10) Pub. No.: US 2016/0088417 A1
(43) Pub. Date: Mar. 24, 2016

(54) HEAD MOUNTED DISPLAY AND METHOD FOR PROVIDING AUDIO CONTENT BY USING SAME

(71) Applicant: INTELLECTUAL DISCOVERY CO., LTD., Seoul (JP)

(72) Inventors: Hongkook KIM, Gwangju-si (KR); Chanjun CHUN, Gwangju-si (KR)

(73) Assignee: INTELLECTUAL DISCOVERY CO., LTD., Seoul (KR)

(21) Appl. No.: 14/787,897

(22) PCT Filed: Jun. 5, 2013
(86) PCT No.: PCT/KR2013/004990

§ 371 Date: Oct. 29, 2015

(30) Foreign Application Priority Data
Apr. 30, 2013 (JP) 10-2013-0048208

(51) Int. Cl. H04S 7/00; H04R 1/02; H04S 5/00

(52) U.S. Cl. CPC H04S 7/303; H04S 5/00; H04R 1/028; H04S 2400/15; H04S 2400/11; H04S 2420/01; H04R 2499/15

(57) ABSTRACT

The present invention relates to a head mounted display (HMD) for adaptively augmenting virtual audio signals according to an actual audio signal-listening environment, and to a method for providing audio content by using same. To this end, the present invention provides the HMD comprising: a processor for controlling the operation of the HMD; a microphone unit for receiving real sound; and an audio output unit for outputting a sound based on a command from the processor, wherein the processor receives the real sound using the microphone unit, obtains a virtual audio signal, extracts spatial audio parameters by using the received real sound; filters the virtual audio signal using the extracted spatial audio parameters, and outputs the filtered virtual audio signal to the audio output unit.

### CROSS-REFERENCE TO RELATED APPLICATIONS

This application claims the benefit of priority from Korean Patent Application No. 10-2013-0048208, filed on Apr. 30, 2013, in the Korean Intellectual Property Office, the disclosure of which is incorporated herein by reference in their entirety. This application is a National Stage Entry of the PCT Application No. PCT/KR2013/004990 filed on Jun. 5, 2013, the entire disclosure of which is also incorporated herein by reference in its entirety.

### BACKGROUND

1. Field

The present disclosure broadly relates to a head mounted display (HMD) and a method of providing audio content using the same, and more specifically to a HMD and a method of providing audio content using the same for providing virtual audio signals which are augmented adaptively according to an actual audio signal-listening environment.

2. Description of Related Art

A head mounted display (HMD) refers to a variety of digital devices which a user wears like a glass and through which multimedia contents are provided to the user. According to weigh reduction and miniaturization of the digital devices, various wearable computers are being developed, and the above-described HMD is widely being used. Beyond a role of a simple display apparatus, the HMD may provide the use with various conveniences and experiments as combined with augmented reality technologies and N-screen technologies.

The conventional augmented reality technologies usually have focused upon visual aspect technologies which synthesize virtual images onto real images of real world. However, in a case that the HMD comprises an audio outputting unit, it can provide the user with the auditory augmented reality as well as the visual augmented reality. In this case, a technology for realistically augmenting virtual audio signals is needed.

### SUMMARY

Exemplary embodiments have objectives to provide a user wearing a HMD with augmented reality audio.

An aspect of exemplary embodiments is to provide a method of harmoniously mixing a real sound and a virtual audio signal for the user.

Another aspect of exemplary embodiments is to provide a method of separating sound sources of real sounds being received and generating a new audio content in real time.

Illustrative, non-limiting embodiments may overcome the above disadvantages and other disadvantages not described above. The inventive concept is not necessarily required to overcome any of the disadvantages described above, and the illustrative, non-limiting embodiments may not overcome any of the problems described above. The appended claims should be consulted to ascertain the true scope of the invention.

In order to resolve the above-described problem, a method of providing audio contents, performed in a Head Mounted Display (HMD) apparatus according to an exemplary embodiment, may comprise receiving real sound by using a microphone; obtaining a virtual audio signal; extracting spatial audio parameters based on the received real sound; filtering the virtual audio signal by using the extracted spatial audio parameters; and outputting the filtered virtual audio signal.

On the other hand, a HMD apparatus according to an exemplary embodiment may comprise a processor controlling operations of the HMD; a microphone unit receiving real sound; and an audio output unit configured to output sounds based on commands of the processor. In the HMD apparatus, the processor may receive the real sound by using the microphone unit, obtains a virtual audio signal, extract spatial audio parameters by using the received real sound, filter the virtual audio signal by using the extracted spatial audio parameters, and output the filtered virtual audio signal through the audio output unit.

According to exemplary embodiments, virtual audio signals can be provided to the user without sense of difference from real sounds.

Also, according to exemplary embodiments, audio contents can be provided based on a position of the user. In this instance, an aspect of exemplary embodiments can make the user listen to the audio contents with sense of realism.

Also, according to another aspect of exemplary embodiments, when recording real sounds, new audio contents can be generated by recording the real sounds in real time together with virtual audio signals.

### BRIEF DESCRIPTION OF DRAWINGS

Non-limiting and non-exhaustive exemplary embodiments will be described in conjunction with the accompanying drawings. Understanding that these drawings depict only exemplary embodiments and are, therefore, not to be intended to limit its scope, the exemplary embodiments will be described with specificity and detail taken in conjunction with the accompanying drawings, in which:

FIG. 1 is a block diagram illustrating a HMD according to an exemplary embodiment;

FIG. 2 is a flow chart illustrating a method of reproducing audio content according to an exemplary embodiment;

FIG. 3 is a flow chart illustrating a method of providing audio content according to another exemplary embodiment;

FIG. 4 is a flow chart illustrating a method of generating audio content according to an exemplary embodiment;

FIGS. 5 to 8 specifically illustrate a method of providing audio content according to exemplary embodiments;

FIG. 9 specifically illustrates a method of generating audio content according to an exemplary embodiment;

FIG. 10 and FIG. 11 illustrate that audio signal of the same content is outputted in different environments according to an exemplary embodiment; and

FIGS. 12 to 14 specifically illustrate a method of providing audio content according to another exemplary embodiment.

### DETAILED DESCRIPTION OF EXEMPLARY EMBODIMENTS

All terms including descriptive or technical terms which are used herein should be construed as having meanings that are obvious to one of ordinary skill in the art. However, the terms may have different meanings according to an intention of one of ordinary skill art, precedent cases, or the appearance of new technologies. Also, some terms may be arbitrarily selected by the applicant, and in this case, the meaning of the selected terms will be described in detail in the detailed description of the invention. Thus, the terms used herein have to be defined based on the meaning of the terms together with the description throughout the specification.

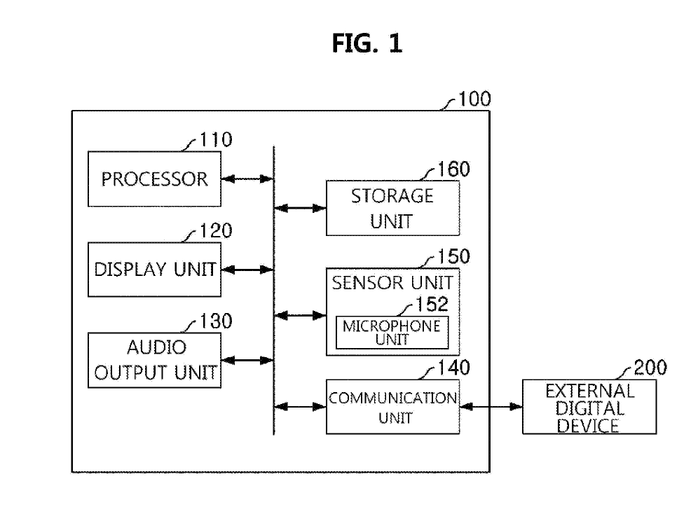

FIG. 1 is a block diagram illustrating a HMD according to an exemplary embodiment.

Referring to FIG. 1, the HMD 100 according to an exemplary embodiment may comprise a processor 110, a display unit 120, an audio output unit 130, a communication unit 140, a sensor unit 150, and a storage unit 160.

First, the display unit 120 may be configured to display images in a display screen. The display unit 120 may output a content being played by the processor 110, or output the images based on control commands of the processor 110. Also, according to an exemplary embodiment, the display unit 120 may display the images based on control commands of an external digital device 200 connected to the HMD 100. For example, the display unit 120 may display a content being played by the external digital device 200 connected to the HMD 100. In this instance, the HMD 100 may receive data from the external digital device 200 via the communication unit 140, and output the images based on the received data.

The audio output unit 130 may comprise an audio output means such as a speaker and an earphone, and a control module configured to control the audio output means. The audio output unit 130 may output sounds based on the content being played by the processor 110 or control commands of the processor 110. The audio output unit 130 according to an exemplary embodiment may include a left channel output unit (not depicted) and a right channel output unit (not depicted). Also, according to an exemplary embodiment, the audio output unit 130 may output an audio signal of the external digital device 200 connected to the HMD 100.

The communication unit 140 may transmit and receive data by performing communications with the external digital device 200 or a server via various protocols. In an exemplary embodiment, the communication unit 140 may access to the server or a cloud via a network, and transmit and receive digital data, for example, the content. Also, according to another exemplary embodiment, the HMD 100 may connect to the external digital device 200 by using the communication unit 140. In this instance, the HMD 100 may be configured to receive display output information of the content being played by the external digital device in real time, and output images through the display unit 120 by using the received information. Also, the HMD 100 may be configured to receive an audio signal of the content being played by the connected external digital device 200 in real time, and output the received audio signal through the audio output unit 130.

The sensor unit 150 may transfer a user input or information on an environment recognized by the HMD 100 to the processor 110 by using at least one sensor equipped within the HMD 100. In this instance, the sensing unit 150 may comprise a plurality of sensing devices. For example, the sensing devices may include various sensing devices such as a gravity sensor, a geomagnetic sensor, a motion sensor, a gyro sensor, an acceleration sensor, an inclination sensor, an illumination sensor, a proximity sensor, an altitude sensor, an olfactory sensor, a temperature sensor, a depth sensor, a pressure sensor, a bending sensor, an audio sensor, a video sensor, a global positioning system (GPS) sensor, and a touch sensor. The sensor unit 150 may refer to the above-described various sensing devices, sense various inputs of the user and user environments, and transfer the sensing results to the processor 110 so that the processor 110 operates according to them. The above-described sensing devices may be included in the HMD 100 as separate elements or as integrated into at least one element.

According to an exemplary embodiment, the sensor unit 150 may comprise a microphone unit 152. The microphone unit 152 may receive a real sound in surroundings of the HMD 100, and transfer it to the processor 110. In this instance, the microphone unit 152 may convert the real sound into an audio signal and transfer the converted audio signal to the processor 110. According to an exemplary embodiment, the microphone unit 152 may comprise a microphone array having a plurality of microphones.

The storage unit 160 may be configured to store digital data including various contents such as video data, audio data, photo data, document data, and applications. The storage unit 150 may be implemented using various digital storage medium such as a flash memory, a random access memory (RAM), or a solid state drive (SSD). Also, the storage unit 150 may store contents which the communication unit 140 receives from the external digital device 200 or the server.

The processor 110 may play the content of the HMD 100 itself or the content received through data communications. Also, the processor 110 may execute various applications, and process data within the device. In addition, the processor 110 may be configured to control the above-described respective units of the HMD 100, and control data communications among the units.

Meanwhile, according to another exemplary embodiment, the HME 100 may be connected to at least one external digital device (e.g. 200), and operate based on control commands of the connected external digital device 200. In this instance, the external digital device 200 may be one of various digital devices which can control the HMD 100. For example, the external digital device 200 may be a smartphone, a personal computer, a personal digital assistant (PDA), a laptop computer, a tablet PC, or a media player. Also, it may be one of other various types of digital devices which can control operations of the HMD. The HMD 100 may perform data transmission/reception with the external digital device 200 by using various wired/wireless communication means. In this case, a near field communication (NFC), a ZigBee, an infra-red communication, a Bluetooth, or a WiFi may be used as the wireless communication means. However, the exemplary embodiment is not restricted thereto. In the exemplary embodiments, the HMD 100 may perform communications as connected to the external digital device 200 through one or combination of the above-described communication means.

In FIG. 1, a block diagram according to an exemplary embodiment, the elements of the HMD 100 are illustrated as separated logically. Therefore, the above-described elements of the HMD 100 may be implemented within a single chip or as multiple chips according to design of the HMD 100.

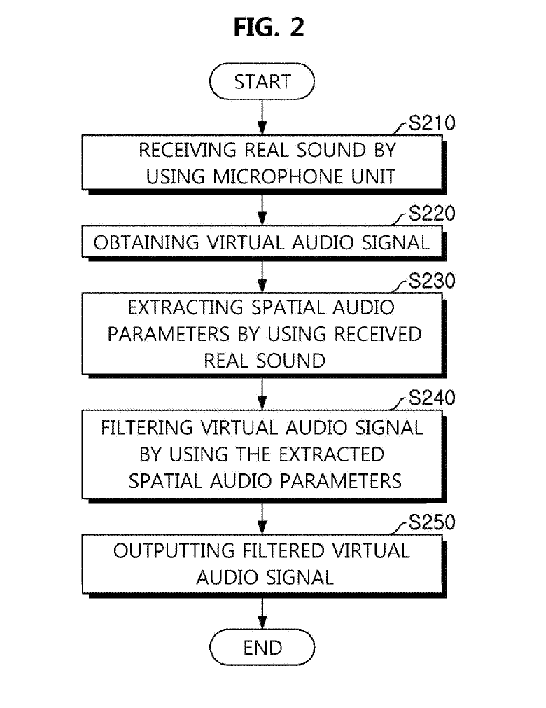

FIG. 2 is a flow chart illustrating a method of reproducing audio content according to an exemplary embodiment. Respective steps of FIG. 2 which will be explained hereinafter may be performed by the HMD of the present disclosure. That is, the processor 110 of the HMD 100 in FIG. 1 may control each step of FIG. 2. Meanwhile, when the HMD 100 is controlled by the external digital device 200 according to another exemplary embodiment, the HMD 100 may perform each step of FIG. 2 according to control commands of the corresponding external digital device 200.

The HMD according to exemplary embodiments may receive a real sound by using the microphone unit (S210). In the exemplary embodiments, the microphone unit may include a single microphone or a microphone array. The microphone unit may convert the received real sound into an audio signal, and transfer the converted audio signal to the processor.

Then, the HMD may obtain a virtual audio signal (S220). The virtual audio signal may include augmented reality audio information to be provided to the user wearing the HMD according to exemplary embodiments. According to an exemplary embodiment, the virtual audio signal may be obtained based on the real sound received in the step S210. That is, the HMD may be configured to analyze the received real sound and obtain the virtual audio signal corresponding to the real sound. According to another exemplary embodiment, the HMD may obtain the virtual audio signal from the storage unit or from the server through the communication unit.

Then, the HMD may extract spatial audio parameters by using the received real sound (S230). In an exemplary embodiment, the spatial audio parameters, as information representing room acoustic of an environment through which the real sound are received, may include various characteristic information related to the sound of a room or a space pursuant a the room, such as a reverberation time, transmission frequency characteristics, a sound insulation performance, etc. For example, the spatial audio parameters may include the following information: i) sound pressure level (SPL), ii) overall strength (G10), iii) reverberation time (RT), iv) early decay time (EDT), v) definition (D50), vi) sound clarity (C80), vii) center time (Ts), viii) speech transmission index (STI), ix) lateral energy fraction (LF), x) lateral efficiency (LF), xi) room response (RR), xii) interaural cross correlation (IACC).

Also, according to exemplary embodiments, the spatial audio parameters may include a room impulse response (RIR). The RIR is a sound pressure level measured in a position of a listener when a sound source is assumed as an impulse function. As a technique for modeling the RIR, there are various models such as an all-zero model based on finite impulse response (FIR) and a pole-zero model based on infinite impulse response (IIR).

Then, the HMD may be configured to filter the virtual audio signal by using the extracted spatial audio parameter (S240). The HMD may generate a filter by using a least one of the spatial audio parameters extracted in the step S230. By filtering the virtual audio signal by using the generated filter, the HMD may apply characteristics of the extracted spatial audio parameters of the step S230 to the virtual audio signal. Thus, the HMD may provide the virtual audio signal to the user with the same effects as the environment through which the real sound is received.

Then, the HMD may be configured to output the filtered virtual audio signal (S250). The HMD may output the filtered virtual audio signal to the audio output unit. According to an exemplary embodiment, the HMD may adjust reproducing characteristics of the filtered virtual audio signal by using the real sound received in the step S210. The reproducing characteristics may include at least one of a play pitch and a play tempo. Meanwhile, according to another exemplary embodiment, the HMD may be configured to obtain a position of a virtual sound source of the virtual audio signal. The position of the virtual sound source may be indicated by the user wearing the HMD, or obtained together with additional information when obtaining the virtual audio signal. The HMD may be configured to convert the virtual audio signal into a three dimensional (3D) audio signal based on the obtained position of the virtual sound source, and output the converted 3D audio signal. In this instance, the 3D audio signal may include a binaural audio signal having 3D effects. More specifically, the HMD may be configured to generate head related transfer function (HRTF) information based on the position of the virtual sound source, and convert the virtual audio signal into the 3D audio signal by using the generated HRTF information. The HRTF means a transfer function between a sound wave output from a sound source at arbitrary position and a sound wave arriving at a tympanic membrane of an ear, and its value varies according to the direction and altitude of the sound source. If audio signals without directional nature (i.e. directivity) are filtered using a HRTF of a specific direction, the user wearing the HMD can feel the filtered signal as a sound transferred from the specific direction.

On the other hand, according to an exemplary embodiment, the HMD may be configured to perform the task of converting the virtual audio signal into the 3D audio signal prior to or subsequent to the step S240. Also, according to another exemplary embodiment, the HMD may be configured to generate a filter in which the spatial audio parameters extracted in the step S230 and the HRTF are integrated, and filter and output the virtual audio signal by using the integrated filter.

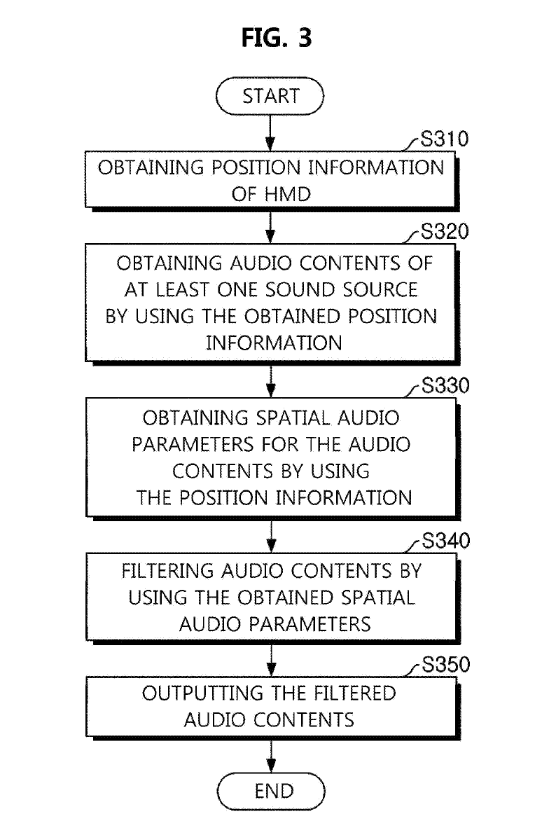

FIG. 3 is a flow chart illustrating a method of providing audio content according to another exemplary embodiment. The respective steps of FIG. 3, which will be explained hereinafter, may be performed by the HMD. In other words, the processor 110 of the HMD 100 in FIG. 1 may control each step of FIG. 3. The parts in the exemplary embodiment of FIG. 3, which are identical or corresponding to the parts of the exemplary embodiment of FIG. 2, will be omitted for simplicity of explanation.

The HMD may obtain position information of the HMD (S310). According to an exemplary embodiment, the HMD may have a GPS sensor, and obtain its position information by using the GPS sensor. According to another exemplary embodiment, the HMD may be configured to obtain position information based on a network service such as WiFi, etc.

Then, the HMD may obtain audio content of one or more sound sources by using the obtained position information (S320). According to exemplary embodiments, the audio content may include an augmented reality audio content to be provided to the user wearing the HMD. The HMD may obtain the audio content of a sound source located adjacently from the HMD from a server or a cloud based on the position information of the HMD. That is, once the HMD transmits its position information to the server or the cloud, the server or cloud may search audio contents of sound sources located adjacently from the HMD by using the position information as query information. Then, the server or cloud may transmit the searched audio contents to the HMD. According to exemplary embodiments, a plurality of sound sources may exist near the HMD, and thus the HMD may obtain audio contents of the plurality of sound sources located near the HMD.

Then, the HMD may obtain spatial audio parameters of the audio content by using the obtained position information (S330). In the exemplary embodiment of FIG. 3, the spatial audio parameters are information for outputting the audio content realistically according to real environments, and may include various characteristic information described in the step S230 of FIG. 2. According to exemplary embodiments, the spatial audio parameters may be determined based on information on a distance and obstacles between a sound source and the HMD. Here, the information on obstacles may be information on various obstacles impeding sound transmission between the sound source and the HMD (e.g. buildings, etc.), and may be obtained from map data based on the position information of the HMD. Even for the audio content of the same sound source, sounds which the listener feels may become different according to the distance and obstacles between the sound source and the listener. Therefore, according to an exemplary embodiment, the HMD may be configured to obtain such the estimated information on the distance and obstacles as the spatial audio parameters. Meanwhile, in case that the HMD obtains audio contents of a plurality of sound sources according to an exemplary embodiment, distances and obstacles between respective sound sources and the HMD may be different. Thus, the HMD according to the exemplary embodiment may obtain a plurality of spatial audio parameter sets each of which corresponds to each of the plurality of sound sources.

Then, the HMD according to an exemplary embodiment may be configured to filter the audio content by using the obtained spatial audio parameters (S340). The HMD may be configured to generate the filter by using at least one of the spatial audio parameters obtained in the step S330. By filtering the audio contents using the generated filter, the HMD may apply characteristics of the spatial audio parameters obtained in the step S330 to the audio content. Therefore, the HMD may provide the audio content to the user with the same effects as the environment through which the real sound is received. In case that the HMD obtains audio contents from a plurality of sound sources, the HMD may filter the audio contents by using spatial audio parameters which respectively correspond to each of the plurality of sound sources.

Then, the HMD according to an exemplary embodiment may output the filtered audio content (S350). The HMD may output the filtered audio content to the audio output unit. Meanwhile, according to an exemplary embodiment, the HMD may obtain direction information of a sound source in reference to the HMD. The direction information may include azimuth information of the sound source in reference to the HMD. The HMD may obtain the direction information by using the position information of the sound source and a value of a gyro sensor of the HMD. The HMD may be configured to convert the audio content into a 3D audio signal based on the obtained direction information and information on a distance between the sound source and the HMD, and output the converted 3D audio signal. More specifically, the HMD may generate HRTF information based on the direction information and the distance information, and convert the audio content into the 3D audio signal by using the generated HRTF information.

According to an exemplary embodiment, the HMD may be configured to perform the task of converting the audio content into the 3D audio signal prior to or subsequent to the step S340. Also, according to another exemplary embodiment, the HMD may be configured to generate a filter in which the spatial audio parameters extracted in the step S330 and the HRTF are integrated, and filter and output the audio content by using the integrated filter.

Meanwhile, according to another exemplary embodiment, the HMD may further obtain time information for providing the audio content. Even for the same site, different sound sources may exist as time varies. The HMD may obtain the time information through the user input, etc. and obtain the audio content by using the time information. That is, the HMD may obtain audio contents of at least one sound source by using the time information together with the position information of the HMD. Therefore, the HMD according to another exemplary embodiment is able to obtain a sound source in a specific site of a specific time, and provide the user with it.

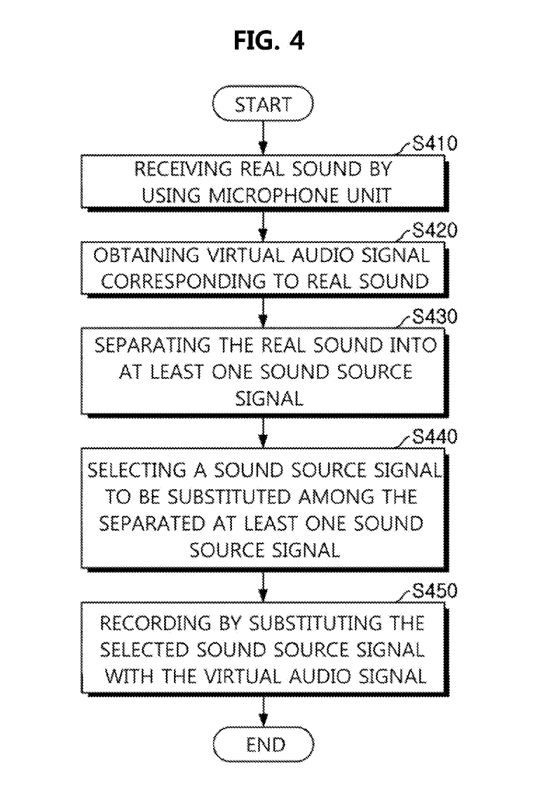

FIG. 4 is a flow chart illustrating a method of generating audio content according to an exemplary embodiment. Each step of FIG. 4, which will be explained hereinafter, may be performed by the HMD of an exemplary embodiment. In other words, the processor 110 of the HMD 100 illustrated in FIG. 1 may control respective steps of FIG. 4. However, the exemplary embodiments of the present disclosure are not restricted thereto, and respective steps of FIG. 4 may be performed by various types of portable devices including the HMD. In the exemplary embodiment of FIG. 4, explanation on parts which are identical to or correspond to those of the exemplary embodiment of FIG. 2 may be omitted for simplicity of explanation.

First, the HMD according to an exemplary embodiment may receive a real sound by using the microphone unit (S410). In the exemplary embodiment, the microphone unit may include a single microphone or a microphone array. The microphone unit may convert the received real sound into an audio signal, and transfer the converted audio signal to the processor.

Then, the HMD may obtain a virtual audio signal corresponding to the real sound (S420). The virtual audio signal may include augmented reality audio information to be provided to the user wearing the HMD according to an exemplary embodiment. According to an exemplary embodiment, the virtual audio signal may be obtained based on the real sound received in the step S410. That is, the HMD may be configured to analyze the received real sound and obtain the virtual audio signal corresponding to the real sound. According to another exemplary embodiment, the HMD may obtain the virtual audio signal from the storage unit or from the server through the communication unit.

Then, the HMD may separate the received real sound into one or more sound source signals (S430). Since signals from one or more sound sources may be included in the received real sound, the HMD may separate the real sound into at least one sound source signal based on positions of respective one or more sound sources. According to an exemplary embodiment, the microphone unit of the HMD may be configured to include a microphone array, and signals from multiple sound sources may be separated by using time differences, pressure level differences, etc. among real sounds received by respective microphones of the microphone array.

Then, the HMD according to an exemplary embodiment may select a sound source signal to be substituted among the separated plurality of sound source signals (S440). According to an exemplary embodiment, the HMD may substitute all or part of the plurality of sound source signals included in the real sound with virtual audio signal, and record them. The user may select the sound source signal to be substituted by using various interfaces. For example, the HMD may be configured to display visual objects which respectively correspond to the extracted sound source signals in the display unit, and the user may select the sound source signal to be substituted by selecting a specific visual object among the display visual objects. Then, the HMD may configure the sound source signal selected by the user as the sound source signal to be substituted.

Then, the HMD may record the sound source signals excluding the selected sound source signal and the virtual audio signal substituting the selected sound source signal (S450). Therefore, the HMD may be configured to generate a new audio content in which the received real sound and the virtual audio signal are combined. Meanwhile, according to an exemplary embodiment, the HMD may perform the recording by adjusting reproducing characteristics of the virtual audio signal based on the real sound received in the step S410. The reproducing characteristics may include at least one of a play pitch and a play tempo. Meanwhile, according to another exemplary embodiment, the HMD may obtain a position of a virtual sound source of the virtual audio signal. The position of the virtual sound source may be indicated by the user wearing the HMD, or obtained as additional information when the virtual audio signal is obtained. Also, according to another exemplary embodiment, the position of the virtual sound source may be determined based on an object corresponding to the sound source signal to be substituted. The HMD may convert the virtual audio signal into 3D audio signal based on the obtained position of the virtual sound source, and output the converted 3D audio signal. More specifically, the HMD may generated HRTF information based on the position of the virtual sound source, and convert the virtual audio signal into the 3D audio signal by using the generated HRTF information.

The sound which we hear in daily life is almost always a reverberation, i.e. a sound mixed with a reflected sound. Accordingly, in case of listening to a sound in a room, we can have feeling of space such as the size of the room and material quality of walls constituting the room according to a degree of the reverberation. Also, in case of listening to a sound in an outdoor environment, we can have different feeling of space as compared to the feeling of space of the indoor listening case. Thus, the exemplary embodiments have objectives to provide the user with a natural and realistic sound by applying artificially-synthesized reverberation effects to the virtual audio signal recorded in a specific environment.

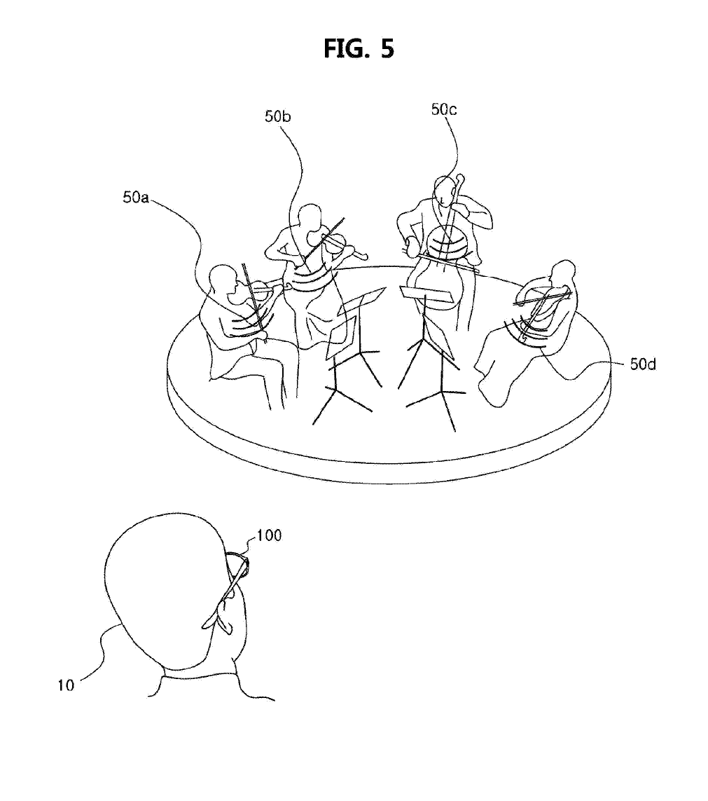

FIGS. 5 to 8 specifically illustrate a method of providing audio content according to exemplary embodiments.

First, FIG. 5 illustrates that the HMD 100 receives a real sound and extracts spatial audio parameters. The HMD 100 according to an exemplary embodiment may have a microphone unit, and receive the real sound through the microphone unit. The real sound received by the HMD 100 may comprise one or more sound source signals. In the embodiment of FIG. 5, the user 10 wearing the HMD 100 is assumed to listen to a string quartet in a room. The real sound received by the HMD 100 may include sound source signals 50a, 50b, 50c, and 50d of respective instruments which play the string quartet. The HMD 100 may use the received real sound to extract the spatial audio parameters corresponding to an environment of the room. As described above, the spatial audio parameters may include various parameters such as the reverberation time, the RIR, etc. Then, the HDM 100 may generate a filter by using at least one of the extracted spatial audio parameters.

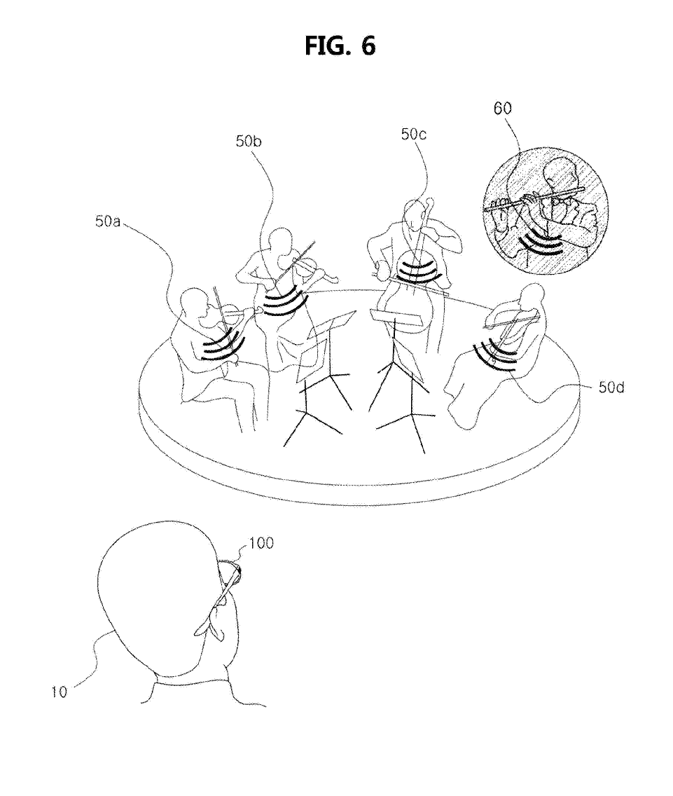

FIG. 6 illustrates that the HMD 100 outputs a virtual audio signal 60 in the environment of FIG. 5 where the real sound is received. The HMD 100 may obtain the virtual audio signal 60. The virtual audio signal 60 may include augmented reality audio information to be provided to the user 10 wearing the HMD 100. According to an exemplary embodiment, the virtual audio signal 60 may be obtained based on the real sound received by the HMD 100. In the exemplary embodiment of FIG. 6, the HMD 100 may obtain the virtual audio signal (e.g. a flute play of the same music) based on the string quartet included in the real sound. The HMD 100 may obtain the virtual audio signal 60 from the storage unit or from the server through the communication unit.

Upon obtaining the virtual audio signal 60, the HMD 100 may filter the virtual audio signal 60 by using the obtained spatial audio parameters of FIG. 5. The HMD 100 may filter the virtual audio signal 60 by using the spatial audio parameters obtained in the room where the string quartet is played thereby applying the characteristics of spatial audio parameters of the room environment to the virtual audio signal 60. Therefore, the HMD 100 is able to provide the user 10 with the virtual audio signal 60 (i.e. the flute play) as the flute is being played in the same room space where the actual string quarter is played.

The HMD 100 may output the filtered virtual audio signal 60 to the audio output unit. In this instance, the HMD 100 may use the received real sound to adjust the reproducing characteristics of the virtual audio signal 60. For example, the HMD 100 may adjust the play pitch and temp of the virtual audio signal 60 so that the play pitch and tempo of the virtual audio signal 60 become identical to those of the actual string quartet in which the flute is played. Also, the HMD 100 may adjust the part of the flute play thereby synchronizing the part of the flute play with the actual string quartet.

Meanwhile, according to another exemplary embodiment, the HMD 100 may obtain a position of a virtual sound source of the virtual audio signal 60. The position of the virtual sound source may be indicated by the user wearing the HMD, or obtained together with additional information when obtaining the virtual audio signals. The HMD may be configured to convert the virtual audio signal into a three dimensional (3D) audio signal based on the obtained position of the virtual sound source. In a case that the audio output unit of the HMD 100 includes a two-channel stereo output unit, the HMD 100 may be configured to make a sound image of the virtual audio signal 60 be oriented toward the position of the virtual sound source. In the exemplary embodiment of FIG. 6, the virtual sound source of the virtual audio signal 60 is assumed to be located in the right-back side of the string quartet payers. Thus, the HMD 100 can provide the user 10 with a virtual experience in which the flute is being played in the right-back side of the string quartet players.

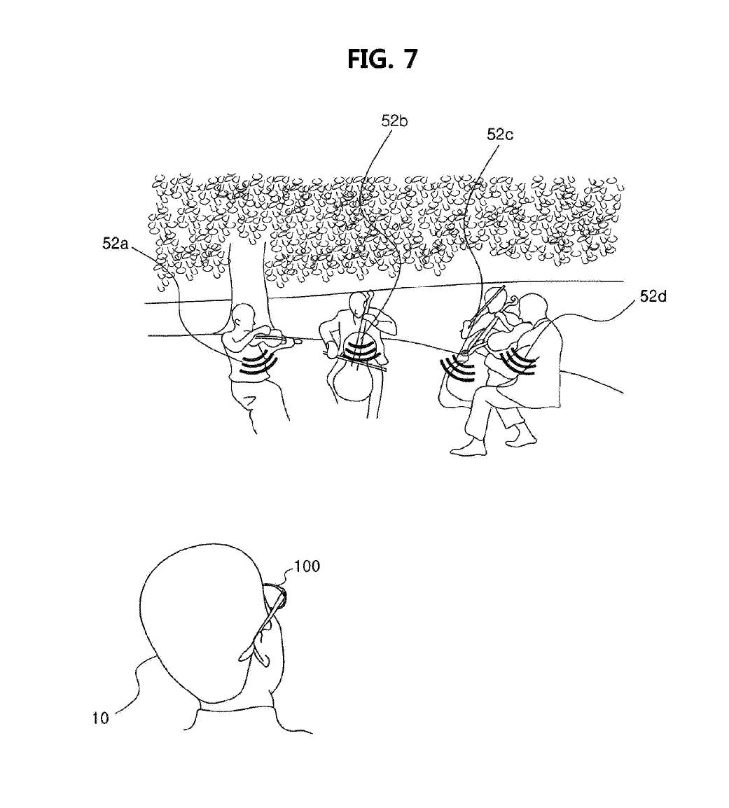

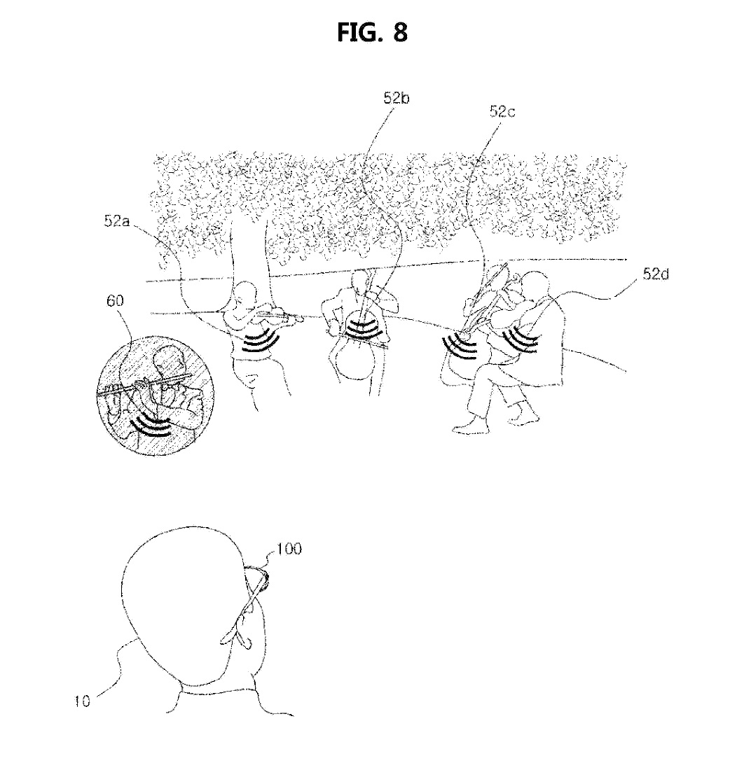

FIG. 7 and FIG. 8 illustrate that the HMD 100 according to an exemplary embodiment outputs virtual audio signal 60 in an outdoor environment. The parts in the exemplary embodiment of FIG. 7 and FIG. 8, which are identical or corresponding to the parts of the exemplary embodiment of FIG. 5 and FIG. 6, will be omitted for simplicity of explanation.

Referring to FIG. 7, the HMD 100 may extract spatial audio parameters by receiving a real sound in the outdoor environment. In the exemplary embodiment of FIG. 7, the real sound received by the HMD 100 may include sound source signals 52a, 52b, 52c, and 52d of respective instruments which play a string quartet in the outdoor space. The HMD 100 may use the received real sounds to extract the spatial audio parameters corresponding to the outdoor environment. Also, the HDM 100 may generate a filter by using at least one of the extracted spatial audio parameters.

Referring to FIG. 8, the HMD 100 outputs a virtual audio signal 60 in the environment of FIG. 7 where the real sound is received. The HMD 100 may filter the virtual audio signal 60 by using the obtained spatial audio parameters of FIG. 7. That is, the HMD 100 may filter the virtual audio signal 60 by using the spatial audio parameters obtained in the outdoor space where the string quartet is actually played thereby applying the characteristics of spatial audio parameters of the outdoor space to the virtual audio signal 60. Thus, the HMD 100 is able to provide the user 10 with the virtual audio signal 60 (i.e. the flute play) as the flute is being played in the outdoor space where the actual string quarter is played. The HMD 100 may output the filtered virtual audio signal 60 to the audio output unit. If the virtual sound source of the virtual audio signal 60 is configured to be located in the left side of the string quartet players, as illustrated in FIG. 8, the HMD 100 can provide the user 10 with a virtual experience in which the flute is being played in the left side of the string quartet players.

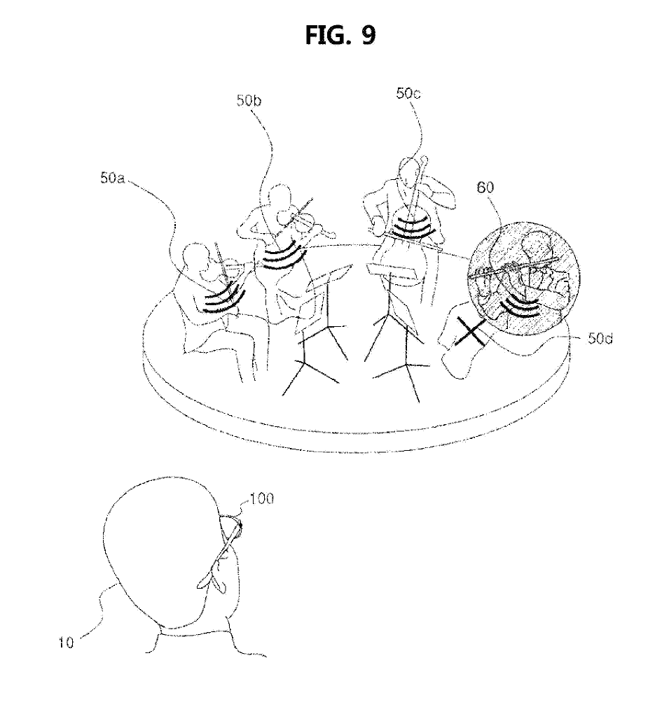

FIG. 9 specifically illustrates a method of generating audio content according to an exemplary embodiment. In the exemplary embodiment of FIG. 9, the HMD 100 generates audio contents in the same environment of FIG. 5 and FIG. 6. However, according to another exemplary embodiment, the audio contents may be generated by various portable devices as well as the HMD 100. The parts in the exemplary embodiment of FIG. 9, which are identical or corresponding to the parts of the exemplary embodiment of FIG. 5 and FIG. 6, will be omitted for simplicity of explanation.

Referring to FIG. 9, the HMD according to an exemplary embodiment may receive real sounds by using the microphone unit, and obtain the virtual audio signal 60 corresponding to the received real sound. The virtual audio signal 60 may include augmented reality audio information to be provided to the user 10 wearing the HMD 100. According to an exemplary embodiment, the virtual audio signal 60 may be obtained based on the real sound received by the HMD 100. Also, the HMD 100 may separate the received real sound into at least one sound source signal 50a, 50b, 50c, and 50d. The microphone unit of the HMD 100 may include a microphone array, and separate respective sound source signals 50a, 50b, 50c, and 50d included in the real sound by using signals received by respective microphones of the microphone array. The HMD 100 may separate the real sound based on positions of sound sources of the respective sound source signals 50a, 50b, 50b, and 50d.

The HMD 100 according to an exemplary embodiment may select a sound source signal to be substituted among the separated plurality of sound source signals 50a, 50b, 50c, and 50d. The HMD 100 may select the sound source signal to be substituted in various ways. For example, the HMD 100 may configure a sound source signal selected by the user 10 wearing the HMD 100 to be the sound source signal to be substituted. The HMD 100 may provide various interfaces for the user to select the sound source signal to be substituted, and select the sound source signal to be substituted through the interfaces. In the exemplary embodiment of FIG. 9, the user 10 selects the sound source signal 50d among the plurality of sound source signals 50a, 50b, 50c, and 50d as the sound source signal to be substituted.

The HMD 100 may record audio signals included in the received real sound. In this instance, the HMD 00 may record the audio signals by substituting the selected sound source signal 50d with the virtual sound signal 60. That is, the HMD 100 may bypass the sound source signal 50d included in the real sounds, and record the virtual sound signal 60 together with the sound source signals 50a, 50b, and 50c. Thus, the HMD 100 may generate a new audio content in which the sound source signals 50a, 50b, and 50c and the virtual audio signal 60 are mixed.

Meanwhile, the HMD 100 may perform the recording while adjusting the reproducing characteristics of the virtual audio signal 60 based on the received real sound. For example, the HMD may adjust the virtual audio signal 60 (e.g. a flute play) thereby maintaining the play tempo and pitch of the virtual audio signal 60 to be identical to those of the actual string quartet. Also, the HMD 100 may synchronize the virtual audio signal (e.g. the flute play) with the actual string quartet by adjusting the part of the flute play based on the actual string quartet.

According to another exemplary embodiment, the HMD may be configured to obtain a position of a virtual sound source of the virtual audio signal. The position of the virtual sound source may be indicated by the user wearing the HMD, or obtained together with additional information when obtaining the virtual audio signal. Also, according to another exemplary embodiment, the position of virtual sound source may be determined based on a position of an object corresponding to the sound source signal 50d to be substituted. The HMD may be configured to convert the virtual audio signal into a three dimensional (3D) audio signal based on the obtained position of the virtual sound source, and record the converted 3D audio signal. The detail implementation of the conversion into the 3D audio signal may be identical to that of the embodiment of FIG. 6.

According to yet another exemplary embodiment, the HMD 100 may extract spatial audio parameters from the received real sound, and record the virtual audio signal 60 filtered using the spatial audio parameters. The extraction of the spatial audio parameters and the filtering of the virtual audio signal 60 may be embodied identically to those of the embodiments of FIG. 5 and FIG. 6.

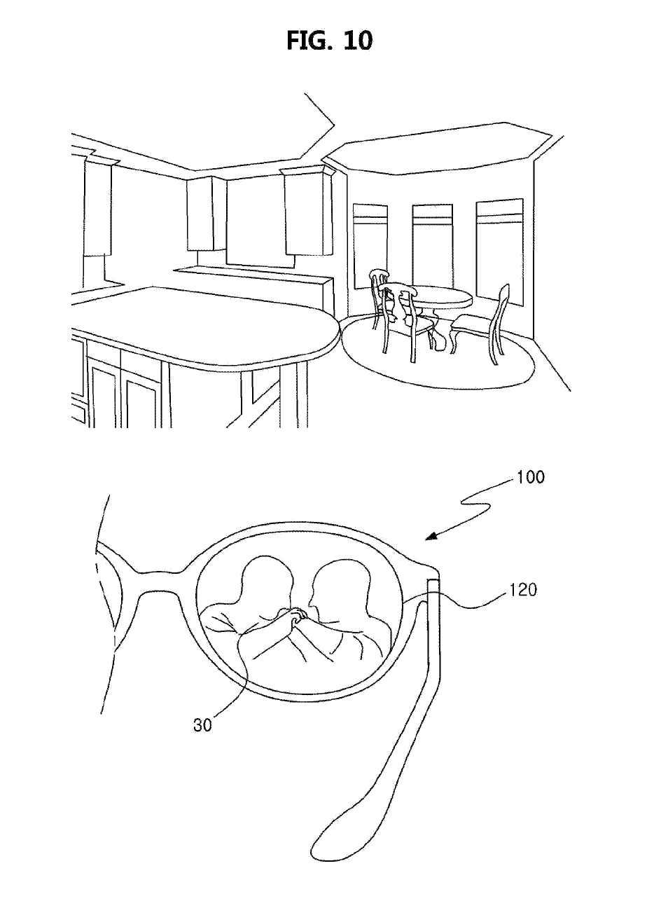

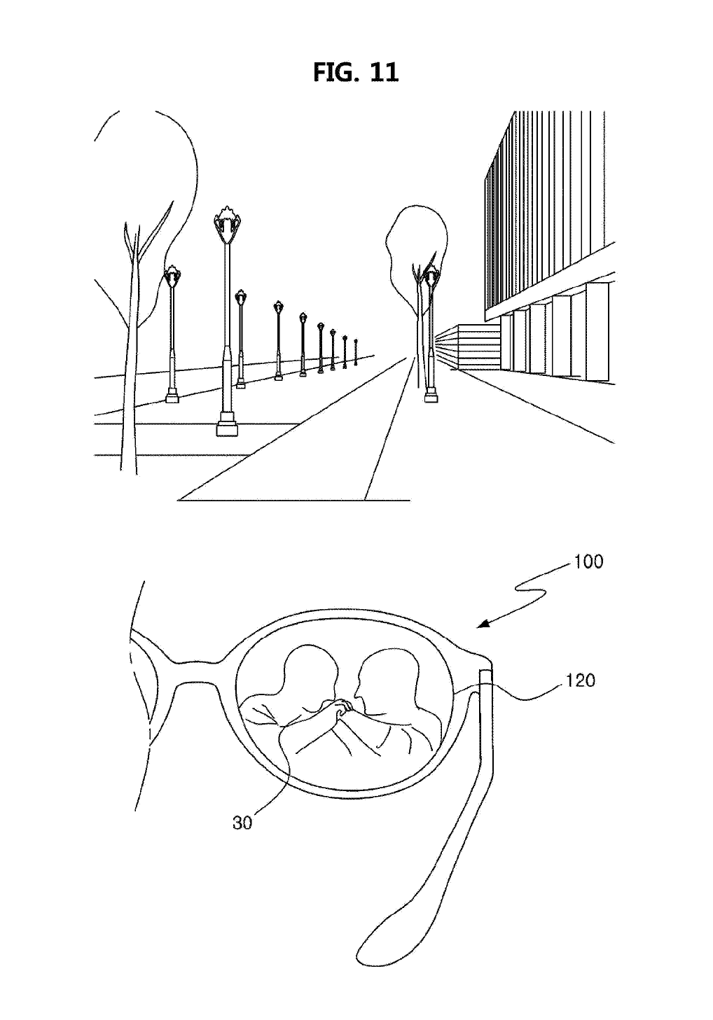

FIG. 10 and FIG. 11 illustrate that audio signals of the same content are outputted in different environments according to an exemplary embodiment.

As illustrated, the user may be provided with a content 30 through the HMD 100. The contents 30 may include various contents such as movie, music, document, video call, navigation information, etc. In a case that the content 30 includes image data, the HMD 100 may output the image data to the display unit 120. Also, voice data of the content 30 may be outputted to the audio output unit of the HMD 100. The HMD 100 may receive a real sound in surrounding areas of the HMD 100, and extract spatial audio parameters based on the received real sound. Also, the HMD 100 may filter the audio signal of the content 30 by using the extracted spatial audio parameters, and output the filtered audio signal.

In the exemplary embodiment of FIG. 10 and FIG. 11, the HMD 100 outputs the same movie. However, as illustrated in FIG. 10 and FIG. 11, according to whether the HMD 100 is located in the room space or in the outdoor space, the extracted spatial audio parameters may be different. The HMD 100 may differently output audio signals of the same content 30 when the HMD 100 is in the room space of FIG. 10 or in the outdoor space of FIG. 11. That is, the HMD 100 may adaptively filter and output the audio signals of the content 30 when the environment where the content is outputted varies. Thus, the user wearing the HMD 100 can be immersed in the content 30 even in varying listening environments.

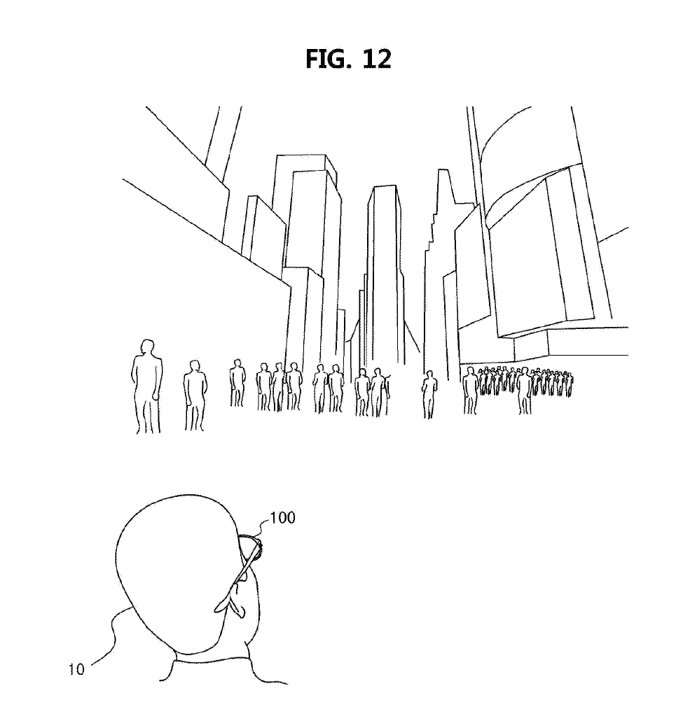

FIGS. 12 to 14 specifically illustrate a method of providing audio content according to another exemplary embodiment. In the exemplary embodiment of FIGS. 12 to 14, the HMD 100 may provide the audio content to the user 10 in augmented reality manner. In the exemplary embodiment of FIGS. 12 to 14, the parts identical or corresponding to the parts of the exemplary embodiment of FIGS. 5 to 8 will be omitted for simplicity of explanation.

Referring to FIG. 12, the user 10 is walking in an outdoor space (e.g. a street in Time Square) as wearing the HMD 100. According to an exemplary embodiment, the HMD 100 may comprise the GPS sensor, and obtain position information using the GPS sensor. According to another exemplary embodiment, the HMD 100 may obtain the position information by using a network service such as WiFi.

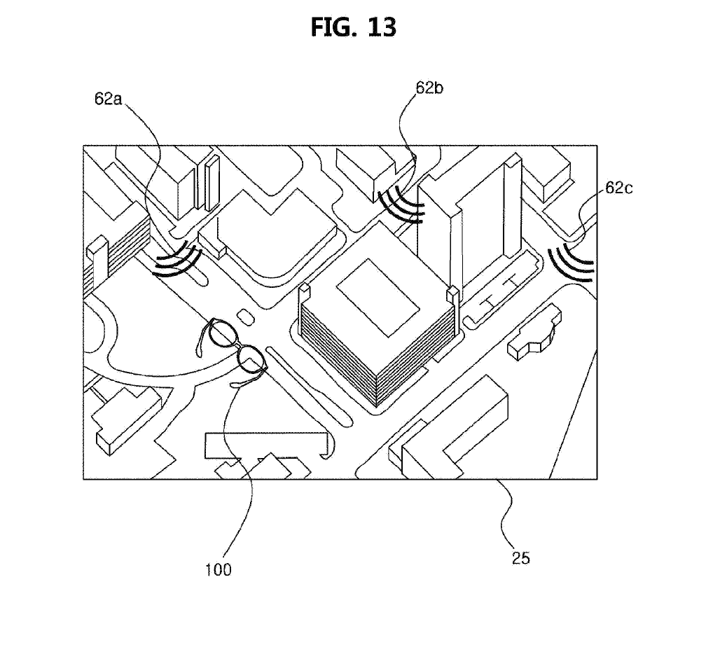

FIG. 13 illustrates map data corresponding to a position detected by the HMD according to an exemplary embodiment. The map data 25 includes information on audio contents 62a, 62b, and 62c of a sound source located adjacent to the HMD 100. The HMD 100 may obtain at least one of the audio contents 62a, 62b, and 62c. As illustrated in FIG. 13, in a case that a plurality of sound sources exist near the position of the HMD 100, the HMD 100 may together obtain audio contents 62a, 62b, and 62c of the plurality of sound sources. Also, the HMD 100 may together obtain position information of respective sound sources of the audio contents 62a, 62b, and 62c.

Meanwhile, according to another exemplary embodiment, the HMD 100 may further obtain time information for providing the audio content. The HMD 100 may obtain the audio content by using both of the position information and the above time information of the HMD 100. For example, if the time information obtained by the HMD 100 indicates the date of Dec. 31, 2012, the HMD 100 may obtain a ‘Happy New Year’ concert dated on Dec. 31, 2012 as the audio content. If the time information obtained by the HMD 100 indicates the date of Dec. 31, 2011, the HMD 100 may obtain a ‘Happy New Year’ concert dated on Dec. 31, 2011 as the audio content.

Also, the HMD 100 may obtain spatial audio parameters for the audio contents 62a, 62b, and 62c by using the obtained position information. The spatial audio parameters are information for outputting the audio contents 62a, 62b, and 62c realistically and adaptively to real environments, and may include various characteristics information described above. According to an exemplary embodiment, the spatial audio parameters may be determined based on distances between the HMD 100 and respective sound sources of the audio contents 62a, 62b, and 62c. Also, the spatial audio parameters may be determined based on obstacles between the HMD 100 and the respective sound sources of the audio contents 62a, 62b, and 62c. Here, information on the obstacles may be information on various impeding elements (e.g. building, etc.) impeding sound transfer between the HMD 100 and the respective sound sources, and may be obtained from the map data 25. Meanwhile, when the HMD 100 obtains the audio contents 62a, 62b, and 62c of the plurality of sound sources together, the distances and the obstacles between the HMD 100 and the respective sound sources may be different from each other. Thus, the HMD 100 may obtain a plurality of spatial audio parameter sets which respectively correspond to the respective sound sources.

The HMD 100 may filter the audio contents 62a, 62b, and 62c by using the obtained spatial audio parameters. If the HMD 100 obtains part of the multiple audio contents 62a, 62b, and 62c, the HMD 100 may obtain only spatial audio parameters corresponding to the obtained part of the multiple audio contents, and filter the obtained audio contents.

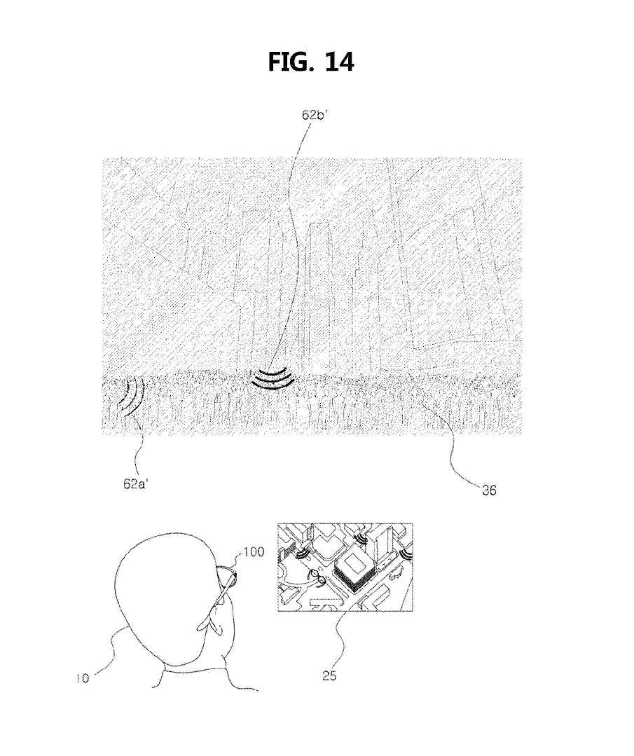

FIG. 14 illustrates that the HMD outputs the filtered audio contents. In the exemplary embodiment of FIG. 14, the HMD 100 may output the filtered audio contents 62a′ and 62b′ to the audio output unit. Meanwhile, the HMD 100 may display image contents 36 corresponding to the filtered audio contents 62a′ and 62b′ through the display unit. For example, the HMD 100 may provide concert contents which have been recorded previously near Time Square as the filtered audio contents 62a′ and 62b′. The HMD 100 may provide the audio contents 62a′ and 62b filtered based on the positions of respective sound sources of the obtained audio contents 62a and 62b and the information on the distances and the obstacles between the HMD 100 and the respective sound sources. Thus, the user wearing the HMD 100 can listen to the audio contents 62a and 62b as the user listens to the concert in a place where the concert is actually played.

According to another exemplary embodiment, the HMD 100 may obtain direction information of respective sound sources in reference to the HMD. The direction information may include azimuth information of the respective sound sources in reference to the HMD. The HMD may obtain the direction information by using the position information of the respective sound sources and a value of a gyro sensor of the HMD. The HMD may be configured to convert the filtered audio contents 62a′ and 62b′ into 3D audio signals based on the obtained direction information and information on distances between the respective sound sources and the HMD, and output the converted 3D audio signals. More specifically, the HMD 100 may generate HRTF information based on the direction information and the distance information, and convert the filtered audio contents 62a′ and 62b′ into the 3D audio signals by using the generated HRTF information.

The HMD described in the present disclosure may be changed into or substituted with a variety of devices in accordance with objectives of various exemplary embodiments. For example, the HMD according to an exemplary embodiment may include a variety of devices which a user can wear and which can provide display means, such as Eye Mounted Display (EMD), eyeglasses, eye piece, eye wear, Head Worn Display (HWD), etc. However, exemplary embodiments according to the present disclosure are not restricted thereto.

While exemplary embodiments have been described above in detail, it should be understood that various modification and changes may be made without departing from the spirit and scope of the inventive concept as defined in the appended claims and their equivalents.

1. A method of providing audio contents by using a head mounted display (HMD) apparatus, the method comprising:
receiving real sound by using a microphone;
obtaining a virtual audio signal;
extracting spatial audio parameters based on the received real sound;
filtering the virtual audio signal by using the extracted spatial audio parameters; and
outputting the filtered virtual audio signal.

2. The method according to claim 1, wherein the spatial audio parameters include at least one of a reverberation time and a room impulse response (RIR) extracted by using the received real sound.

3. The method according to claim 1, wherein the virtual audio signal is obtained based on the received real sound.

4. The method according to claim 1, wherein, in the outputting the virtual audio signal, reproducing characteristics of the virtual audio signal are adjusted by using the received real sound.

5. The method according to claim 4, wherein the reproducing characteristics include at least one of a play pitch and a play tempo.

6. The method according to claim 1,
further comprising obtaining a position of a virtual sound source of the virtual audio signal,
wherein, in the outputting the virtual audio signal, a three-dimensional (3D) audio signal into which the virtual audio signal is converted based on the position of sound source is outputted.

7. The method according to claim 6, further comprising:
generating a head related transfer function (HRTF) information based on the position of the virtual sound source; and
converting the virtual audio signal into the 3D audio signal by using the generated HRTF information.

8. A head mounted display (HMD) apparatus comprising:
a processor controlling operations of the HMD;
a microphone unit receiving real sound; and
an audio output unit configured to output sounds based on commands of the processor,
wherein the processor receives the real sound by using the microphone unit, obtains a virtual audio signal, extracts spatial audio parameters by using the received real sound, filters the virtual audio signal by using the extracted spatial audio parameters, and outputs the filtered virtual audio signal through the audio output unit.
